(19) United States
(12) Patent Application Publication
(10) Pub. No.: US 2026/0291994 A1
(43) Pub. Date: Sep. 24, 2026

(54) SYSTEM, DOMESTIC COMMUNICATION INSTALLATION AND CENTRAL MANAGEMENT UNIT

(71) Applicant: Horst Siedle GmbH & Co. KG, Furtwangen (DE)

(72) Inventors: Christoph Weber, Stuttgart (DE); Peter Strobel, Freiburg (DE)

(21) Appl. No.: 19/576,434

(22) Filed: Mar. 24, 2026

(30) Foreign Application Priority Data
Mar. 24, 2025 (DE) 102025111226.6

(51) Int. Cl. H04L 9/40

(52) U.S. Cl. CPC H04L 63/20; H04L 63/101; H04L 63/102

(57) ABSTRACT

The invention relates to a system for managing a domestic communication installation with a plurality of domestic communication terminals, which are connected via a data network, and a central management unit. The central management unit stores and manages a digital image of the installation with uniquely identified domestic communication terminals and synchronizes operational and configuration data. Via provided communication connections, different user roles are able to access the configuration and management functions.

### BACKGROUND OF INVENTION

The invention relates to a system for managing a domestic communication installation, in particular for configuration, administration and synchronization of domestic communication terminals within a building or building complex with a central management unit. The invention further relates to a domestic communication installation as well as to a central management unit for managing a digital image of the domestic communication installation.

### TECHNICAL BACKGROUND

The present invention relates to the field of domestic communication as part of home automation. Home automation is situated in the context of smart living, which refers to solutions in the private or commercial residential and working environment that are tailored to the specific needs of occupants of private residential buildings, apartment blocks or commercial buildings, in which devices, systems and technologies are used that create greater efficiency, comfort, cost-effectiveness, flexibility and security.

One aspect of home automation relates to domestic communication by means of corresponding domestic communication terminals or intercom systems. Modern domestic communication installations typically comprise a plurality of different domestic communication terminals, which are coupled to one another via a connection network, such as, for example, Ethernet or a bus system. In this context, a distinction is made between so-called indoor stations, which are arranged in a protected area within the house or a corresponding residential unit, and so-called door stations or outdoor stations, which are arranged in the public area in front of or directly at the house or building door, underground garage entrances, accesses to properties or the like and via which visitors can establish a communication connection with occupants. These domestic communication terminals usually comprise a bell or a bell button panel, a door opener, an intercom system, a camera and a display, via which a bidirectional communication between visitor and house or apartment owner is enabled. Such domestic communication installations are generally known, so that this is not described in more detail.

Domestic communication installations are used in residential and commercial properties in order to enable communication between an outdoor station, for example at a building entrance, and one or more indoor stations within the respective residential units or usage units. Such installations primarily serve for voice communication and partly also for image communication and enable users to grant access to the building to visitors.

Conventional systems generally consist of an outdoor station with call buttons and speaking function as well as a plurality of indoor stations, which are adapted to accept calls, to display call signals and, if applicable, to control a door opener. Depending on the level of expansion, further domestic communication terminals can be foreseen, for example switching actuators, sensors, cameras or applications on mobile terminals.

Modern domestic communication installations as well as their domestic communication terminals are increasingly executed in an IP-based manner and are thus capable of being coupled to the Internet. By using an IP-based network, the individual components can be flexibly connected to one another and additional functions can be implemented. DE 10 2011 077 013 A1 describes, for example, such a domestic communication installation with an IP-based domestic communication network.

With an increasing number of terminals and increasing complexity of the functions, the requirements for simple installation, configuration and management of the entire installation increase. In particular, the unique assignment of users to individual domestic communication terminals as well as the configuration and adaptation of authorizations and settings often represent a high manual effort in known systems and require special knowledge.

Furthermore, conventional installations are often limited in their functionality to local operation, such that location-independent management or a role-based assignment of rights for different user groups—such as installers, managers or occupants—is only possible to a limited extent.

### SUMMARY OF THE INVENTION

Against this background, the object of the present invention is to provide an improved system for managing a domestic communication installation, which enables simple and efficient configuration, management and use of the installation and, in particular, supports the integration of different user roles as well as flexible expandability of the installation.

This object is achieved by a system for managing a domestic communication installation, by a domestic communication installation as well as by a central management unit having the features of the independent patent claims. Further advantageous embodiments of the invention are the subject-matter of the dependent patent claims.

Accordingly, there is provided the following:
A system for managing a domestic communication installation, which comprises a plurality of domestic communication terminals and a central management unit. The domestic communication terminals are connected to one another via a data network. The central management unit is adapted to store and to manage a digital image of the domestic communication installation. Each physical domestic communication terminal is registered in the digital image by a unique identification. The central management unit is further adapted to synchronize operational and configuration data from the digital image with the corresponding domestic communication terminals. Furthermore, the central management unit provides communication connections via which users, by means of user applications and/or administration interfaces, are able to access the configuration and management functions of the domestic communication installation.
A domestic communication installation, which comprises a plurality of domestic communication terminals. The domestic communication terminals are connected to one another via an IP-based data network. The domestic communication installation is adapted to be communicatively coupled to a central management unit via the IP-based data network in order to exchange operational and configuration data.
A central management unit for a domestic communication installation, comprising a processing unit for managing a digital image of the domestic communication installation. The digital image comprises a representation of the uniquely identified domestic communication terminals. The central management unit is adapted to synchronize operational and configuration data from the digital image with the domestic communication terminals. The central management unit is further adapted to provide administration interfaces and/or user applications via which different users are able to access the configuration and management functions of the domestic communication installation.

The present invention is based on the recognition that modern domestic communication installations increasingly comprise complex structures and a plurality of physical domestic communication terminals, which are connected to one another in a network. In this context, new challenges arise with regard to the installation, configuration, management and also the subsequent maintenance of such installations.

In particular, it has been recognized that the assignment and management of the individual domestic communication terminals within the installation causes considerable effort and is prone to errors if no central, structured management is performed. This problem is exacerbated by the necessity to be able to adapt the configurations flexibly to changing users or changing conditions over the lifecycle of the installation.

It is therefore an idea of the present invention to take this recognition into account and to create a system in which all physical domestic communication terminals are connected to one another via a data network and are controlled via a central management unit. This management unit stores and manages a digital image of the domestic communication installation, in which all physical components are registered with their unique identification. This image or the configurations performed in the image can then be synchronized automatically or upon request with the configuration of the physical components.

As a result, not only a structured and error-reduced management is enabled, but also a clear basis is created in order to centrally detect, manage and synchronize operational and configuration data of the domestic communication installation with the respective terminals. This concept additionally enables targeted access to the configuration and management functions to be granted to different users in different roles, whereby a flexible and scalable handling of the entire domestic communication installation is achieved.

In the context of the present invention, the term domestic communication installation denotes a communication system for a building or a building complex, which serves for the voice and/or visual communication between different areas, in particular between an outdoor area and individual residential units. The domestic communication installation enables, for example, a visitor in front of the building to be identified acoustically and visually and to enable access authorization to him. Furthermore, the installation can comprise control functions for building-related technical devices, such as controlling a door opener or detecting access data.

Domestic communication terminals, within the scope of the invention, denote those functional components of the domestic communication installation which provide communication or control functions independently and are connected to one another via the data network of the installation. These include, in particular, door stations, via which call signals can be triggered from outside and audio and video communication can be initiated, indoor stations for receiving calls and for controlling the installation, switching actuators for actuating door openers, as well as optionally further components. The latter can, in particular, comprise devices for detecting authentication features, such as RFID readers, PIN keypads or biometric sensors, but can also provide further functionalities.

The central management unit, within the meaning of the invention, refers to a central entity which serves for managing, configuration and monitoring of the domestic communication installation. It is in particular adapted to store and to manage a digital image of the domestic communication installation including the corresponding domestic communication terminals. In this context, the digital image represents the structure and the state of the real installation and enables central control as well as coordination of the terminals. The central management unit can be implemented as an independent hardware component with corresponding software or as a distributed system which combines various server-based or cloud-based services. It provides interfaces for different user roles and performs synchronization of configuration and operational data with the domestic communication terminals.

The digital image of the domestic communication installation refers to a representation of the real installation stored in the central management unit. It comprises, in particular, the registered domestic communication terminals including their unique identification as well as the corresponding configuration and operational data. The digital image forms the basis for controlling and managing the installation and enables changes to be performed centrally and subsequently to be synchronized with the physical domestic communication terminals. It additionally serves for traceability of changes and facilitates maintenance or expansion work.

User applications, within the meaning of the invention, refer to software applications which are preferably executed on mobile terminals or computers of users and which enable an interaction with the domestic communication installation. They serve in particular for individually adapting user-specific settings or for remote interaction with the installation, for example for receiving call signals or for triggering a door opener.

Administration interfaces, by contrast, refer to user interfaces provided specifically for configuration and management of the installation. They enable authorized users, such as installers or managers, to create configuration data, to process configuration data or to manage existing settings. The administration interfaces can be implemented as web-based solutions or as local software solutions and, in this context, access the central management unit.

The synchronization of operational and configuration data refers to, within the meaning of the invention, the alignment of the data stored in the central management unit with the actual domestic communication terminals of the installation. In this context, in particular configuration changes or updates, which have been performed on the digital image, are transmitted to the corresponding domestic communication terminals. The synchronization ensures that the physical domestic communication terminals always correspond to the current configuration state. Likewise, if required, operational data can also be transmitted from the domestic communication terminals to the central management unit, for example for diagnostic or maintenance purposes.

For the synchronization, a suitable data connection is established between the central management unit and the domestic communication installation. This connection can, in particular, be established via the Internet or another IP-based data network. In this context, it is possible that individual domestic communication terminals communicate directly with the management unit. Alternatively, one of the domestic communication terminals can also act as a central transmission device, which performs the communication with the management unit and distributes the synchronized data within the installation to the further domestic communication terminals.

In a preferred embodiment, the domestic communication terminals are connected to one another via an IP-based data network. By using an IP-based data network, standardized and flexible data communication between the domestic communication terminals is enabled. In this context, the data network can be designed as a wired network, for example as an Ethernet network, or as a wireless network, for example based on WLAN. Combinations of wired and wireless network segments are likewise conceivable, whereby the domestic communication installation can be adapted flexibly to different structural conditions and requirements. Via the IP-based data network, the domestic communication installation can additionally be communicatively coupled to the central management unit, such that an exchange of operational and configuration data as well as a synchronization with the digital image of the domestic communication installation can be performed.

In a preferred embodiment, each domestic communication terminal comprises a unique identification. This ensures that each physical domestic communication terminal can be uniquely detected and distinguished from one another within the domestic communication installation. The identification feature is preferably similar to a serial number and stored in the respective domestic communication terminal. For simple detection during installation or commissioning, this identification feature is additionally applied in a readable, in particular machine-readable form, for example as a QR code or barcode, on the packaging and/or the housing of the domestic communication terminal. As a result, the identification can be performed either by machine reading or, if required, also manually by reading and inputting the identifier. The central management unit is adapted to detect the unique identification and to register the respective domestic communication terminals in the digital image of the domestic communication installation. This ensures a unique and traceable assignment of the real components to the virtual representation in the system, which is advantageous in particular for configuration, maintenance and subsequent expansions of the installation.

In a further preferred embodiment, the central management unit is adapted to manage user roles with different authorizations for the configuration and management functions of the domestic communication installation. By means of the role-based authorization structure, it is ensured that different user groups are able to access only those functions and data which correspond to their respective area of responsibility. As a result, a clear separation of responsibilities is enabled and, at the same time, data security and system security are increased. The management of the user roles is performed centrally in the management unit. Each role can have specific rights for configuration of individual parameters or for access to specific components of the domestic communication installation. This allows a flexible and scalable design of the user rights and of the system administration, which can be adapted to different application scenarios and user requirements.

In a further preferred embodiment, different user roles can be defined, to which specific authorizations for the configuration and management functions of the domestic communication installation are assigned. In this respect, for example, the following are included:
an installer role, which enables an authorized user, such as an electrician or service technician, to perform commissioning and to configure the domestic communication installation. Via this role, individual domestic communication terminals can be registered, configured and, for example, prepared in the digital image for operation.
a manager role, which is authorized for administration of the domestic communication installation and for managing user rights. A user with this role, such as a building manager or caretaker, can perform system-wide settings and manage user accounts and access authorizations.
a user role, which enables a resident or user of a building unit to perform individual settings. These include, in particular, the selection of the ringtone, the setting of the call signal volume or further personal preferences in connection with the use of the domestic communication terminals.

By means of this role allocation, a clear separation of responsibilities and access rights is ensured.

By means of this role allocation there is ensured a clear separation of responsibilities and access rights.

In a further preferred embodiment, at least one domestic communication terminal, in particular a door station, comprises a display element which is adapted to represent labelings. Via this display element, in particular the names of the users assigned to the respective building units can be displayed. In this context, the central management unit is designed so that the labeling for a digital display can be updated by transmitting corresponding configuration data to the respective domestic communication terminal. This makes it possible, for example, in the event of a change of user, to automatically change the displayed names at the door station.

Alternatively, or additionally, the central management unit is adapted to, for a static labeling, upon a change in the user assignment, to automatically generate and provide an order for creating a new labeling. Such an order can, for example, be used for producing and delivering a physical nameplate.

Thanks to this design, there is the possibility of flexible and efficient adaptation of the labeling to changing user assignments, both for digital and classic static labeling.

In a further preferred embodiment, the system comprises an external management system, which is adapted to manage and to provide user-specific data and/or data associated with a building unit. Such a management system can, for example, be a building management system or an enterprise resource planning system (ERP system), in which relevant information relating to the individual users or building units is stored. The central management unit is, in this context, adapted to assign the data provided from the external management system to a call button or a display element of a domestic communication terminal and use for updating a digital display. As a result, it is, for example, possible, in the event of a change in user data in the external system, to automatically adapt the display at the door station accordingly.

Alternatively, or additionally, the central management unit is designed such that, based on the data provided from the external management system, an order for a new static labeling can be automatically generated and provided. In this way, consistent and automated maintenance of the labelings is supported both for digital labelings and for static displays.

In a further preferred embodiment, the system comprises a central storage unit, which is adapted to be coupled to the domestic communication installation. The central storage unit serves for storing communication events, wherein these can in particular be images and/or voice messages which have been generated by at least one domestic communication terminal. Such communication events can arise, for example, during a ringing process at the door station, when a visitor is detected or a voice message is left. The central storage unit is further adapted to provide stored communication events to at least one domestic communication terminal and/or a user application. As a result, a user can retrieve these stored events at a later point in time, for example via an indoor station or a user application executed on a mobile terminal. In this context, it is, inter alia, enabled to trace missed visit events or to listen to left voice messages. The central storage unit can either be implemented as an integral component of the central management unit or alternatively be provided as a separate unit outside the building. In the latter case, the central storage unit is communicatively coupled via data connections to the domestic communication installation as well as to the central management unit.

In a preferred embodiment, the central management unit comprises a processing unit for managing and synchronization of the domestic communication terminals as well as a management platform for providing administration interfaces. The processing unit is adapted to manage a digital image of the domestic communication installation including the uniquely identified domestic communication terminals. Furthermore, the processing unit is adapted to synchronize operational and configuration data from the digital image with the domestic communication terminals. The management platform is adapted to provide administration interfaces via which configuration data for the domestic communication installation can be created and managed.

In a further preferred embodiment, the system comprises at least one first mobile terminal, which executes a user application. The user application is in particular adapted to communicate with the central management unit in order to manage user-specific settings for the domestic communication installation. This can, for example, comprise adapting ringtones, volumes or individual display and control functions. In this context, the communication is typically performed via a wireless data connection, in particular via the Internet or a mobile network. Furthermore, the user application can be adapted to retrieve communication events from the central storage unit. Such communication events include, for example, image or voice messages which have been detected at a door station and stored in the storage unit. In this way, the user can also access past events irrespective of location, in order, for example, to obtain information about missed visitors. Furthermore, the user application enables a remote interaction with at least one domestic communication terminal. As a result, the user can communicate with a person at the door station from any location or actuate a door opener.

In a further preferred embodiment, the system comprises at least one second mobile terminal, which executes an installation application. The installation application is in particular provided for commissioning and configuration of the domestic communication installation by an installer or a comparable skilled person. It provides two alternative or combinable operating modes:

On the one hand, the installation application is adapted to communicate directly with the domestic communication installation. This is preferably performed via a local wireless connection, for example by means of WLAN or Bluetooth. Via this connection, the application can identify individual domestic communication terminals. The identification is performed on the basis of the unique identification features of the terminals, which are recognized and detected by the installation application. Based thereon, the installer can create a configuration of the identified domestic communication terminals, which is subsequently transmitted directly to the domestic communication installation or to the respective terminals. As a result, immediate and efficient commissioning of the installation is enabled, without a connection to the central management unit being required.

Alternatively, or additionally, the installation application is adapted to retrieve configuration data from the central management unit. The retrieved configuration data can be processed by the installation application in order to perform, for example, adaptations to the terminal settings or to the assignments. Subsequently, the processed configuration data can be transmitted back to the central management unit, where they are provided for further use or for transmission to the domestic communication installation.

This embodiment enables a flexible and efficient handling of the configuration, since both a direct on-site interaction with the installation and a central processing of configuration via the management unit are supported.

In a further preferred embodiment, the domestic communication installation comprises at least one domestic communication terminal, which is adapted to detect an authentication feature. Such a domestic communication terminal can, for example, be a door station or an access terminal, which is equipped with suitable sensors or readers. Various types of features can be considered as authentication features, such as a PIN code, biometric features (e.g. fingerprint or facial recognition) or an electronic identification means such as an RFID transponder or a chip card. The central management unit is, in this context, adapted to use the detected authentication features for managing access authorizations. In this case, specific access rights can be assigned to individual authentication features in order to control access to specific areas or functions. Furthermore, the central management unit is adapted to transmit authorization changes to the respective domestic communication terminal. As a result, the domestic communication terminal is enabled to enable the access authorization directly using the detected authentication feature.

In a further preferred embodiment, the central management unit comprises a central storage unit. The central storage unit is, in this context, adapted to be coupled to the domestic communication installation and to store communication events, in particular images and/or voice messages, from at least one domestic communication terminal. The central management unit is further adapted to access communication events stored in the central storage unit and to forward them for display to at least one domestic communication terminal and/or a user application. By means of this embodiment, it is enabled to centrally store communication events and, if required, to provide them in a targeted manner for display or further processing. In this context, the central storage unit can either be implemented as an integral component of the central management unit or be implemented as a separate component, which is connected to the central management unit.

### SUMMARY OF THE DRAWING

The present invention is explained in more detail below using the examples of embodiments indicated in the schematic figures of the drawings. These show:

FIG. 1 a schematic representation of a system for managing a domestic communication installation with a plurality of domestic communication terminals and a central management unit;

FIG. 2 an overview of a plurality of users with different user roles and their interaction with the domestic communication installation and the central management unit according to a first embodiment;

FIG. 3 an extended embodiment of a system of a communication installation and a plurality of users with different user roles.

The accompanying figures are intended to provide a further understanding of the embodiments of the invention. They illustrate embodiments and, in connection with the description, serve to explain principles and concepts of the invention. Further embodiments and many of the advantages mentioned result with regard to the drawings. The elements of the drawings are not necessarily shown to scale in relation to one another.

In the figures of the drawing, identical elements, features, and components that have the same function and effect—unless stated otherwise—are each provided with the same reference signs.

### DESCRIPTION OF EXEMPLARY EMBODIMENTS

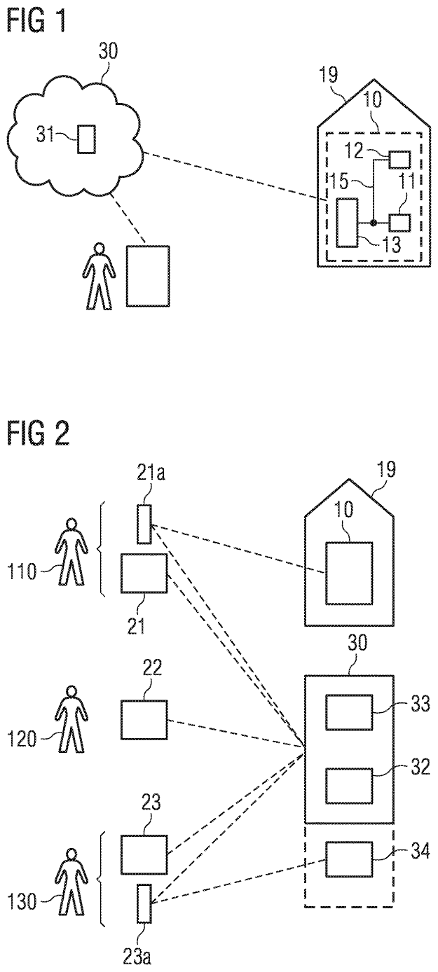

FIG. 1 shows an exemplary embodiment of a system according to the invention for managing a domestic communication installation 10, which is installed in a building 19. The domestic communication installation 10 comprises a plurality of domestic communication terminals 11, 12 and 13, which are provided within the building 19.

The domestic communication terminals 11 to 13 are connected to one another via an IP-based data network 15. In the illustrated embodiment, this data network 15 is executed as a local network within the building 19. It can be implemented both as a wired network, for example as an Ethernet network, and as a wireless network, for example by means of WLAN. A hybrid form is likewise provided, in which individual domestic communication terminals are integrated into the network in a wired manner and others in a wireless manner. In a wired embodiment, the data network 15 can additionally be used for supplying power to the terminals, for example by means of Power over Ethernet (PoE). In the case of wirelessly connected components, by contrast, a separate power supply is required.

As examples of domestic communication terminals, a door station 11, an indoor station 12 as well as a control device or switching actuator 13 are illustrated in this embodiment. The switching actuator 13 is, for example, adapted to control and to actuate a door opener. Furthermore, additional domestic communication terminals can be provided, for example sensors or cameras, but also components for detecting authentication features such as a reader for PIN codes, biometric features or RFID transponders. Such a reader can be configured as a separate component or be integrated into the door station 11.

After successful configuration, the domestic communication installation 10 is fundamentally able to operate autonomously and to provide the basic functions of domestic communication. Additionally, however, the domestic communication installation 10 can be coupled via a data connection, for example an Internet connection, to a central management unit 30 arranged outside the building 19.

Via this data connection, the central management unit 30 can provide various functions. In particular, it is possible to transmit a configuration previously created or modified in the central management unit 30 to the domestic communication installation 10, such that the individual domestic communication terminals 11 to 13 are set according to this prepared configuration. Likewise, software or firmware updates can be applied via the data connection. Furthermore, additional functionalities can be provided which go beyond the basic functions of the autonomous installation.

The central management unit 30 is, in this context, adapted to store and to manage a digital image 31 of the domestic communication installation 10 including the uniquely identified domestic communication terminals. This digital image forms the basis for central control and management of the entire domestic communication installation 10 and enables targeted synchronization of operational and configuration data between the management unit 30 and the domestic communication terminals 11 to 13.

In order to create the digital image 31 of the domestic communication installation 10, an installer or configurator initially detects the unique identification of the domestic communication terminals 11 to 13 installed in the real installation. In this respect, each domestic communication terminal 11-13 is provided with an identification feature, which is preferably applied in the form of a machine-readable code, for example a QR code, on the respective domestic communication terminal 11-13 and/or on the packaging.

The installer or configurator can detect the identification features of the individual domestic communication terminals 11-13 by means of a suitable reader or a mobile installation application on a mobile terminal. Alternatively, or additionally, the identification can also be performed by manual input of a serial number applied to the domestic communication terminal 11-13. Via the detected identification features, the central management unit 30 can uniquely determine the type and the respective functionalities of the individual domestic communication terminals 11-13.

Based on these detected data, the digital image 31 of the domestic communication installation 10 is created in the central management unit 30. Within this digital image 31, the individual domestic communication terminals 11-13 are represented according to their functionality and configurable parameters are defined. The created configuration can subsequently be transmitted via the data connection to the domestic communication installation 10, such that the respective domestic communication terminals 11-13 are automatically configured according to the digital image 31.

Via the central management unit 30, various additional functionalities can additionally be provided which support and extend the administration and configuration of the domestic communication installation 10. Thus, the management unit 30 can, for example, be used to adapt the configuration of the installation 10 by, for example, changing or extending the assignment between individual call buttons at the door station 11 and the corresponding indoor stations 12.

Furthermore, the central management unit 30 enables enabling optional functionalities of individual domestic communication terminals 11-13 or of the entire installation 10. The user management can also be performed via the central management unit 30, wherein individual authorizations or access rights can be assigned to individual users and adapted if required.

The embodiments described below show, by way of example, various possibilities for implementing these functions.

FIG. 2 schematically shows the integration of different user roles in the management and operation of the domestic communication installation 10. In the illustrated example, three users 110, 120 and 130 are provided, to which different roles are assigned.

A first user 110 is, in this context, assigned the role of an installer. The user 110, within the scope of this role, performs the commissioning and configuration of the domestic communication installation 10 as well as the execution of maintenance work or modifications during operation. Among the tasks of the installer is, inter alia, detecting the unique identification of the real physical domestic communication terminals 11-13, for example by scanning applied machine-readable codes, in order to transfer these into the digital image 31 of the central management unit 30.

Furthermore, the installer 110 can define the installation locations of the individual domestic communication terminals 11-13 within the building 19 as well as configure their assignment. In this respect, this includes, in particular, linking call buttons of a door station 11 with corresponding indoor stations 12 in order to ensure that incoming call signals are signaled at the correct target points. The transmission of software or firmware updates to individual domestic communication terminals 11-13 of the installation 10 can also be performed by the installer 110.

A second user 120 is assigned the role of a manager. The manager 120 can, in particular, access the domestic communication installation 10 via the central management unit 30 and is responsible for its administration during ongoing operation. Among the tasks of the manager 120 is, inter alia, managing user rights within the system. Thus, the manager 120 can, for example, define which functions remain available to the installer 110 or whether certain modifications by the installer are to be blocked or restricted.

Furthermore, the manager 120 is authorized to create users 130 within the system, to manage them and to assign corresponding rights to them. In particular, in the event of a user change, for example when the occupants of a residential unit within the building 19 change, the manager 120 is able to block the previous access rights, to create new users 130 and to update the assignments within the installation 10 accordingly.

This update can also comprise adapting labelings at the domestic communication terminals 11, such as, for example, a nameplate at a call button of a door station 11. In this way, it is ensured that the current assignment between the occupants and the respective call buttons is always correctly represented. The adaptation of the labeling at the domestic communication terminals 11, in particular at a call button of a door station 11, can be performed in two different ways.

In a first embodiment, the domestic communication terminal 11 is provided with a static labeling, for example a printed or engraved nameplate. In the event of a user change, the manager 120 can automatically generate an order for producing a new labeling via the central management unit 30. This order can be transmitted to an external labeling service, which is responsible for creating and delivering the new nameplates. The new labeling can then be exchanged on site.

In an alternative embodiment, the domestic communication terminal 11, in particular the door station 11, comprises a digital display element which is adapted to represent the labeling. In this case, the manager 120 can cause an update of the displayed labeling via the central management unit 30. In this respect, corresponding configuration data are transmitted to the digital display element, whereby the current assignment to the respective user 130 can be adapted directly and without physical exchange of the labeling.

Both variants enable the labeling to be updated efficiently and reliably in the event of a change of users and thus ensure a unique assignment of call buttons to the respective users.

The user 130 can, in addition to using the domestic communication terminals 11-13 assigned to him, in particular the corresponding indoor stations 12, additionally use a mobile application on a mobile terminal 23a. The authorization to use this application is granted and managed by the manager 120 via the central management unit 30. Via the mobile terminal 23a, the user 130 can adapt various user-specific parameters of the domestic communication terminals assigned to him. In this respect, these include, for example, setting the volume, selecting a call signal or further individual configurations.

Furthermore, the mobile application on the terminal 23a can be used as an additional virtual indoor station. The user 130 thereby obtains the possibility, for example, to accept an incoming call at the door station 11 also via the mobile terminal 23a or to initiate a door opening. Furthermore, the application can enable the user 130 to access data stored in a storage unit 34. In this way, stored communication events such as images or voice messages can be retrieved and displayed.

The central management unit 30 comprises a processing unit 32 as well as a management platform 33. The processing unit 32 is in particular responsible for managing the digital image 31 of the domestic communication installation 10. In this respect, the operational and configuration data of the individual domestic communication terminals 11-13 are stored and managed. Likewise, the synchronization of these data with the corresponding physical domestic communication terminals of the installation 10 is performed by the processing unit 32.

The management platform 33 is adapted to provide administration interfaces via which users with corresponding authorizations obtain access to the configuration and management functions of the installation. Via these interfaces, configuration data can, for example, be created, adapted or managed.

The central management unit 30 comprises a processing unit 32 as well as a management platform 33. The processing unit 32 manages the digital image of the domestic communication installation 10 and synchronizes the configuration and operational data with the domestic communication terminals 11-13. The management platform 33 provides administration interfaces which enable the manager 120 to adapt configurations of the installation and to manage user rights. If the corresponding authorizations are present, an installer 110 can also undertake changes to the configuration via these administration interfaces.

Additionally, a central storage unit 34 is provided, which can either be executed as part of the management unit 30 or be implemented as a separate external unit. Communication events such as images and voice messages are stored in this storage unit 34. Access to the stored data can be performed both via the management unit 30 and directly by authorized users, for example via a mobile terminal 23a.

The installer 110 can access an administration interface of the management platform 33 provided for him via a suitable terminal 21, for example a desktop computer, a tablet or a comparable device. Via this administration interface, the installer 110 can perform configuration tasks, in particular detect the individual domestic communication terminals 11-13 on the basis of their unique identification and assign them to the digital image 31 of the management unit 30.

Within the scope of maintenance work or in the event of a defect of a domestic communication terminal 11-13, the installer 110 can identify the affected terminal in the digital image 31 via the administration interface. Subsequently, the unique identification of a replacement device can be detected and stored. The previous configuration of the defective domestic communication terminal 11-13 is then automatically assigned to the new replacement device. As a result, it is enabled that the functionality of the domestic communication installation 10 is seamlessly maintained without renewed manual configuration of the replacement device.

Alternatively, or additionally, the installer 110 can use a mobile terminal 21a, on which a dedicated installation application is executed. Via this installation application, the installer 110 is able to directly scan the unique identification of a domestic communication terminal 11, 12, 13, wherein the identification can, for example, be applied as a QR code or in another suitable form on the respective domestic communication terminal 11, 12, 13 or its packaging. After detecting the unique identification, the installer 110 can, with the installation application, create a configuration of the domestic communication installation 10, which takes into account both the recorded domestic communication terminals 11, 12, 13 and their assignment within the domestic communication installation 10.

The created configuration can be transmitted wirelessly directly to the domestic communication installation 10 by establishing a wireless communication connection between the mobile terminal 21a and one of the domestic communication terminals 11, 12, 13. Via the IP-based data network 15 of the domestic communication installation 10, the distribution of the configuration to the further domestic communication terminals 11, 12, 13 is subsequently performed. Alternatively, it is possible that the installation application establishes a connection to the central management unit 30, such that the installer 110 can retrieve a configuration already stored in the central management unit 30 on the basis of the digital image 31 or can transmit a newly created or modified configuration to the central management unit 30. If a connection exists between the central management unit 30 and the domestic communication installation 10, the configuration stored there can be transmitted to the domestic communication installation 10 and its domestic communication terminals 11, 12, 13.

The manager 120 can connect to the management platform 33 of the central management unit 30 via a terminal 22, which can, for example, be a desktop computer, a tablet or a comparable device. Via this connection, an administration interface provided for his role is provided to the manager 120. Via the administration interface, the manager 120 obtains access to the configuration and management functions of the domestic communication installation 10.

The manager 120 is authorized to adapt the configuration of the domestic communication installation 10, for example by changing assignments between call buttons of the door station 11 and the indoor stations 12 or by enabling additional functions of individual domestic communication terminals 11, 12, 13. Furthermore, the manager 120 can perform the user management. In this respect, this includes, in particular, creating new users 130, assigning corresponding authorizations to them or blocking existing users 130.

In the event of a user change, such as, for example, a change of occupants of a residential unit, the manager 120 is additionally able to perform all necessary adaptations in the digital image 31. This includes, in particular, assigning the new users 130 to the corresponding domestic communication terminals 11, 12, 13 as well as updating labelings at the door station 11.

Depending on the embodiment of the domestic communication installation 10, the manager 120 can, in this context, both adapt the digital labeling of a display element of the door station 11 and, in the case of a static labeling, generate an order for producing and providing a new nameplate.

Additionally, the manager 120 has the possibility to enable or to restrict certain changes and authorizations for the installer 110, such that the latter can also perform changes via the management platform 33 if required.

The user 130 can connect to the management platform 33 of the central management unit 30 via a terminal 23, which can, for example, be a desktop computer, a tablet or a comparable device. Via this connection, a user interface provided for him is provided to the user 130, via which individual adaptations of the domestic communication terminals 11, 12, 13 assigned to him can be performed.

In this respect, this includes, in particular, the possibility to configure parameters such as volume, call signal or further user-specific settings. Depending on the respective embodiment, additional functions of the domestic communication installation 10 can also be provided to the user 130 via the user interface, for example retrieving images or messages from the storage unit 34.

Furthermore, a mobile application is available to the user 130, which is executed on a mobile terminal 23a. Via this mobile application, the user 130 can also access the functions of the domestic communication installation 10 assigned to him. The mobile application enables the user 130 to operate the domestic communication installation 10 also remotely.

In this respect, this includes, inter alia, the possibility to accept an incoming call at the door station 11 via the mobile terminal 23a, to communicate with a visitor or to initiate a door opening. In addition, the mobile application provides the user 130 with access to communication events stored in the storage unit 34, such as, for example, images or voice messages. These stored data can be retrieved and displayed via the mobile application, wherein the access is performed either via the central management unit 30 or—depending on the embodiment—a direct connection to the storage unit 34 is also possible.

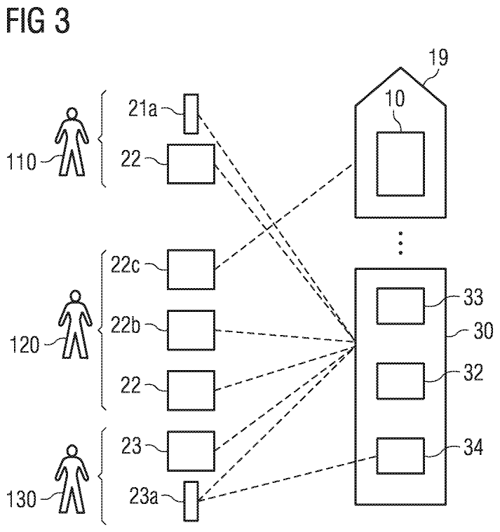

FIG. 3 shows the system in an extended embodiment. The illustrated elements and their functionalities substantially correspond to those of FIG. 2 described above, such that the explanations given therein also apply to this embodiment.

The configuration shown in FIG. 3 differs, however, in that an external management system 22b can optionally be provided. This external management system 22b can, for example, be an enterprise resource planning system (ERP system). This external management system is adapted to provide relevant data for operation and configuration of the domestic communication installation 10.

In particular, data can be provided via this, which are used for the labeling of individual domestic communication terminals, such as, for example, call buttons at door stations 11. The data provided by the external management system 22b can be received and processed by the central management unit 30. On this basis, the central management unit 30 can either automatically perform changes to the labeling or submit corresponding proposals to the manager 120 for confirmation and execution.

The connection of such an external management system 22b represents an optional extension of the system and is not necessarily required for operation of the domestic communication installation 10.

Furthermore, the system shown in FIG. 3 can, in an extended embodiment, also comprise an access management. This can be administered entirely via the central management unit 30 and, in particular, via the management platform 33 by the manager 120. A prerequisite for this is that corresponding components for detecting authentication features are integrated into the domestic communication installation 10. Such components can be executed as separate domestic communication terminals or be integrated into existing domestic communication terminals, such as, for example, the door station 11. As authentication features, for example a PIN input, biometric features or contactless identification means such as RFID transponders can be considered.

Alternatively, or additionally, a separate external access management system 22c can be provided, which is coupled to the domestic communication installation 10 via a suitable data connection. Via the external access management system 22c, access authorizations can be managed and authentication features can be checked, wherein the system 22c either operates independently or interacts with the central management unit 30.

The connection of such an external access management system 22c, like the connection of the external management system 22b, represents an optional extension of the system and is not necessarily required for the basic operation of the domestic communication installation 10.

Optionally, the user 130 can also have limited possibilities for adapting the access management. In particular, it can be provided that the user 130 is authorized to manage certain authentication features himself for access to the rooms assigned to him. Thus, the user 130 can, for example, create an individual PIN code or authorize or block certain RFID chips or cards. This configuration can be performed by the user 130 either via a suitable external component or via the mobile application available to him on the mobile terminal 23a.

The present invention thus relates to a system for managing a domestic communication installation 10, which is in particular adapted for use in larger residential installations or building complexes. The domestic communication installation 10 comprises a plurality of domestic communication terminals 11, 12, 13, for example door stations 11, indoor stations 12 as well as switching actuators 13 for controlling door openers. The domestic communication terminals 11, 12, 13 are connected to one another via an IP-based data network 15, wherein hybrid forms of wired and wireless connections are also provided. In this context, power supply can be performed via the data network 15 by means of Power over Ethernet or via separate lines.

The core of the invention is the central management unit 30, which manages a digital image 31 of the domestic communication installation 10. Each physical domestic communication terminal 11, 12, 13 is represented by a unique identification and registered in the digital image 31. The central management unit 30 is adapted to synchronize operational and configuration data with the domestic communication terminals 11, 12, 13 and to provide communication connections via which different user roles are able to access the configuration and management functions.

To support operation, different user roles are foreseen, including an installer role for commissioning and subsequent maintenance of the domestic communication installation 10, a manager role for central administration and a user role for individual adaptations. Suitable user interfaces are provided for each role, which can be accessed both via stationary and mobile devices.

The detection of the unique identification of the domestic communication terminals 11, 12, 13 is preferably performed by the installer 110 via a mobile terminal 21a with an installation application, for example by scanning a machine-readable code. On this basis, the configuration can be created, adapted and, if required, also updated in the event of a device replacement.

Particular emphasis is placed on the possibility of automated or digital labeling of the door stations 11. Via the central management unit 30, a digital display can be labeled directly with the correct user data. Alternatively, in the case of a static labeling, an order for the physical creation of the new labeling is automatically triggered. Optionally, data from an external management system 22b, such as an enterprise resource planning system ERP, can be used for this purpose.

In addition, a central storage unit 34 is foreseen, in which communication events such as image and voice data are stored. Access to these data can be performed by the user 130 via a mobile terminal 23a or by other authorized user roles.

An extension of the invention comprises the integration of components for access control, wherein domestic communication terminals 11, 12, 13 are adapted to detect authentication features and to manage access authorizations via these. Here as well, management by the manager 120 or optionally by the user 130 is foreseen.

The central management unit 30 is divided into a processing unit 32 for synchronization of the domestic communication terminals 11, 12, 13 and a management platform 33 for providing administration interfaces. In addition, it is foreseen that external systems such as the external management system 22b or a separate system 22c for access management can also be connected in order to provide additional information or functions.

Overall, the system enables a flexible and scalable management of domestic communication installations 10, which is particularly suitable for larger building complexes and supports both central and user-specific configurations and interactions.

Thus, the present invention relates to a system for managing a domestic communication installation with a plurality of domestic communication terminals, which are connected via a data network, and a central management unit. The central management unit stores and manages a digital image of the installation with uniquely identified domestic communication terminals and synchronizes operational and configuration data. Via provided communication connections, different user roles are able to access the configuration and management functions.

1. A system for managing a domestic communication installation, comprising
a plurality of domestic communication terminals which are connected to one another via a data network,
a central management unit, which is adapted to store and to manage a digital image of the domestic communication installation, wherein each physical domestic communication terminal is registered in the digital image by a unique identification, wherein the central management unit is adapted to
synchronize operational and configuration data from the digital image with the corresponding domestic communication terminals, and
to provide communication connections via which users, by means of user applications and/or administration interfaces, are able to access the configuration and management functions of the domestic communication installation.

2. The system according to claim 1,
characterized in that
the domestic communication terminals are connected to one another via an IP-based data network, wherein the domestic communication installation is adapted to be communicatively coupled to the central management unit via the IP-based data network.

3. The system according to claim 1,
characterized in that
each domestic communication terminal comprises a unique identification, wherein the central management unit is adapted to detect this unique identification and to register the respective domestic communication terminals in the digital image of the domestic communication installation.

4. The system according to claim 1,
characterized in that
the central management unit is adapted to manage user roles with different authorizations for the configuration and management functions of the domestic communication installation.

5. The system according to claim 4,
characterized in that
the user roles comprise at least:
an installer role, which is authorized to perform commissioning and configuration of the domestic communication installation,
a manager role, which is authorized to administer the domestic communication installation and to manage the user rights, and/or
a user role, which is authorized to individually adapt the user-specific parameters of the domestic communication installation.

6. The system according to claim 1,
characterized in that
at least one domestic communication terminal, in particular a door station, comprises a display element which is adapted to represent labelings, in particular names of assigned users, wherein the central management unit is adapted to
update the labeling for a digital display by transmitting configuration data to the domestic communication terminal, and/or
for a static labeling, upon a change in the user assignment, to automatically generate and provide an order for a new labeling.

7. The system according to claim 6,
characterized in that
it comprises an external management system, which is adapted to manage and to provide user-specific data and/or data associated with a building unit, wherein the central management unit is adapted to
assign the data provided from the external management system to a call button or a display element of a domestic communication terminal and to use for updating a digital display, and/or
based on the provided data, to automatically generate and provide an order for a new static labeling.

8. The system according to claim 1,
characterized in that
it comprises a central storage unit, which is adapted to be coupled to the domestic communication installation and to store communication events, in particular images and/or voice messages, from at least one domestic communication terminal, wherein the central storage unit is adapted to provide stored communication events to at least one domestic communication terminal and/or a user application.

9. The system according to claim 1,
characterized in that
the central management unit comprises a processing unit for managing and synchronization of the domestic communication terminals as well as a management platform for providing administration interfaces,
wherein the processing unit is adapted to manage the digital image of the domestic communication installation including the corresponding domestic communication terminals and to synchronize operational and configuration data from the digital image with the domestic communication terminals,
and wherein the management platform is adapted to provide administration interfaces via which configuration data are created and managed.

10. The system according to claim 1,
characterized in that
it comprises at least one first mobile terminal, which executes a user application, wherein the user application is adapted to
communicate with the central management unit in order to manage user-specific settings for the domestic communication installation,
to retrieve communication events from the central storage unit, and/or
to enable a remote interaction with at least one domestic communication terminal.

11. The system according to claim 1,
characterized in that
it comprises at least one second mobile terminal, which executes an installation application, wherein the installation application is adapted to
directly communicate with the domestic communication installation in order to identify domestic communication terminals, to create a configuration of the identified domestic communication terminals and to transmit the created configuration to the domestic communication terminals of the domestic communication installation, and/or
to retrieve configuration data from the central management unit, to process the retrieved configuration data and/or to transmit processed configuration data to the central management unit for further use or for transmission to the domestic communication installation.

12. The system according to claim 1,
characterized in that
the domestic communication installation comprises at least one domestic communication terminal, which is adapted to detect an authentication feature, wherein the central management unit is adapted to
manage access authorizations using the detected authentication feature and to assign them to specific users, and
to transmit authorization changes to the domestic communication terminal such that it is able to enable an access authorization using the detected authentication feature.

13. A domestic communication installation, comprising a plurality of domestic communication terminals, which are connected to one another via an IP-based data network, wherein the domestic communication installation is adapted to be communicatively coupled to a central management unit via the IP-based data network in order to exchange operational and configuration data.

14. A central management unit (30) for a domestic communication installation, comprising a processing unit for managing a digital image of the domestic communication installation wherein the digital image comprises a representation of the uniquely identified domestic communication terminals, wherein the central management unit is adapted to synchronize operational and configuration data from the digital image with the domestic communication terminals, and
to provide administration interfaces and/or user applications via which different users are able to access the configuration and management functions of the domestic communication installation.

15. The central management unit according to claim 14,
characterized by
a central storage unit, which is adapted to be coupled to the domestic communication installation and to store communication events, in particular images and/or voice messages, from at least one domestic communication terminal, wherein the central management unit is adapted to access communication events from the central storage unit and to forward them for display to at least one domestic communication terminal and/or a user application.
